(19) United States
(12) Patent Application Publication
(10) Pub. No.: US 2007/0101339 A1
(43) Pub. Date: May 3, 2007

(54) System for and method of multi-dimensional resource management

(76) Inventor: Kenneth W. Shrum, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/263,667

(22) Filed: Oct. 31, 2005

(51) Int. Cl. G06F 9/46

(52) U.S. Cl. 718/104

(57) ABSTRACT

A method, system and program product for managing system resources in a system with a potentially large number of resources and tasks that need exclusive use of the resources in order to run. The system is comprised of a means of describing resources and resource selection criteria, a means of describing a task's complete resource requirements as a set of named resource selection criteria, a means of supporting alternative resource requirements for a given task and also for prioritizing across all tasks and all resource requirements by attaching a priority to each resource requirement and allowing multiple alternative resource requirements per tasks, and an efficient means of selecting simultaneously one distinct resource from each of N possibly overlapping sets of candidate resources such that any given selection is chosen with equal probability (i.e. is fair). Techniques are disclosed for gaining significant performance including employing greedy resource acquisition

### BACKGROUND OF THE INVENTION

This invention relates to a method, system, and program product for managing one or more resources of a data network.

Managing the use of resources in a data network is a fundamental part of system design. In conventional systems, there are various system resources available to tasks, and each task typically requires exclusive use of the jointly shared resources for a certain period of time to complete its execution. A resource manager may operate in conjunction with a quality of service manager that provides quality of service (QOS) guarantees to individual processes or tasks. One such test manager is the Wireless Quality of Service Manager (WQM) of Agilent Technologies, Inc. WQM is an active call test system, which tests cell-phone-based services by attempting to use them from one cell phone to another. A description of the capabilities of WQM is provided in the Agilent Technologies, Inc. Information Sheet entitled “Agilent OSS QoS Manager” viewable at http://we.home.agilent.com/cgi-bin/bvpub/agilent/Product/cp₁₃ Product.jsp?OID=536882909 &NAV_ID=-536885380.536882909.00&LANGUAGE CODE=eng&COUNTRY_CODE=ZZ&CT=PRODUCT&JPID=/comms/firehunter, the contents of which are hereby incorporated by reference in their entirety.

At some time when resources are available such that a task can be run, the task's “call back” will be invoked, which would in turn make a remote Java call back to WQM to start the test with the actual resources to be used. When the test completes, WQM would again invoke a resource management system to release the resources, e.g. interfaces and Identity Modules (IMs.)

WQM regularly deals with hundreds of interfaces, a few thousand tests, and up to tens of thousands of IMs. In addition, WQM deals with the fact that certain groups within a given customer paid for particular interfaces and/or IMs, and their tests should consequently have some priority for using those resources.

Several of the goals of resource management systems, which are not limited to the environment of wireless communication test systems, may be stated more generally. In any data network there exist a set of jointly shared resources. There is a desire to manage acquisition and release of the resources by the tasks such that exclusive access to resources is guaranteed, and that there is a high utilization of resources. Certain resources are heavily contended for, so it is important that the resources are kept busy. It is additionally desirable to achieve “fair” use of the resources, i.e., whereby available resource matching a selection criteria has an equal probability to be selected, It is further desirable to achieve “fair” selection of tasks, meaning that any task that could acquire resources matching all of its selection criteria has equal probability to be selected. The acquisition and release of resources should also be reasonably scalable and “safe”, meaning deadlock-free, usable from multiple threads, etc. While some efforts have been made to address these goals, a need remains for an improved method, system and program product for managing resources in a system.

### SUMMARY OF THE INVENTION

In a first aspect, the present invention provides a software-implemented method of resource management in a system including a plurality of resources S for servicing a plurality of tasks T. The method employs simultaneous greedy acquisition principles for efficient resource utilization. The method performs upon task submission and release of resources, as an atomic operation, for each resource requirement Rᵢ of a plurality of resource requirements R each associated with a task Tₖ requiring execution, in random order, the iterative steps of choosing a group of available resources Sⱼ satisfying resource requirements Rᵢ such that no resource in Sⱼ is selected more than once. If such a group of available resources Sⱼ exists, the chosen available resources Sⱼ are acquired, making them no longer available. The acquired resources are handed off to Tₖ, and all of the resource requirements Rᵢ are removed from the plurality of resource requirements R.

Each of the plurality of resources S is characterized by one or more named attributes, each having at least one value. Each of the plurality of resource requirements Rᵢ is characterized by a group of at least one named resource selection criteria C, and each of the resource selection criteria is expressed as a boolean expression.

More than one resource requirement Rᵢ is typically associated with each task Tₖ, and each resource requirement Rᵢ preferably has associated with it some priority Pⱼ, which permits consideration of the plurality of resource requirements R in prioritized groups, and within each group the Rᵢ in random order. The method selects the available resources Sⱼ with equal probability from the set of all such groups Sₖ satisfying the resource requirements Rᵢ.

In another aspect, the present invention provides a system and resource manager for managing a plurality of resources for servicing a plurality of tasks. The system and resource manager operate so as to permit acquisition and release of resources in accordance with the methods described above.

In another aspect, the present invention provides a machine-readable computer program product encoded on one or more programmable storage devices. The computer program product is executable by one or more processors to perform method steps for managing a plurality of resources S of a system for servicing a plurality of tasks T.

These and other aspects of the present invention are now described in more detail with reference to the following figures.

### BRIEF DESCRIPTION OF THE FIGURES

For a better understanding of the present invention, together with other and further objects thereof, reference is made to the accompanying drawings and detailed description, wherein:

FIG. 1 is a block diagram illustrating the relationships between Tasks, Resource Requirements, and Resource Selection Criteria in accordance with an embodiment of the invention;

FIG. 2 is a table providing examples of Resources and associated attributes in accordance with an embodiment of the invention;

FIG. 3 is a block diagram illustrating the relationships among Tasks, Resource Requirements, and Resource Selection Criteria and their respective internal state representations in accordance with an embodiment of the invention;

FIG. 4 is a process flow diagram illustrating a method of resource management in accordance with the present invention;

FIG. 5 is a process flow diagram illustrating a method of releasing and/or adding resources to a system in accordance with the present invention;

FIG. 6 is a process flow diagram illustrating a method of uniform random selection of resource groups in accordance with the present invention; and

FIG. 7 is an illustration of a specific operating environment for a resource manager in accordance with the present invention.

### DETAILED DESCRIPTION OF CERTAIN EMBODIMENTS OF THE INVENTION

Conceptual Overview

In accordance with one embodiment of the present invention, there is provided a system for managing plurality of resources S for servicing a plurality of tasks T requiring execution, the system including a resource manager comprised at least in part of a processor-readable computer program product encoded on one or more programmable storage devices.

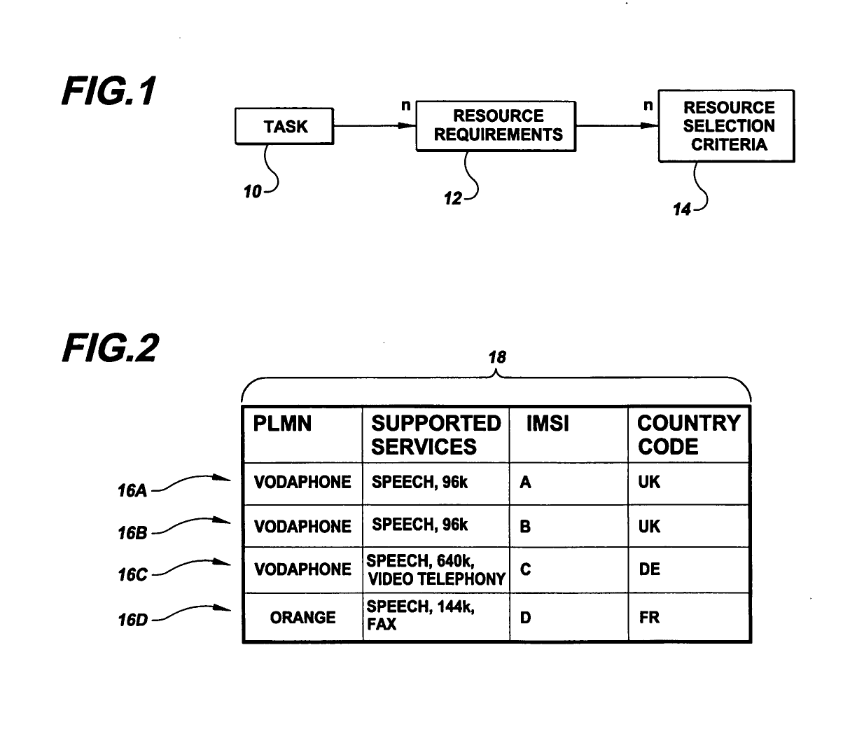

The resource manager typically receives simultaneously submitted requests to run a few hundred Tasks T, each task Tₖ representing a single test, either one-sided or two-sided. With reference to FIG. 1, each Task Tₖ 10 requiring execution needs exclusive use of certain resources from the set of resources S for some period of time, after which the task will release the resources. Each Task 10 describes what resources it requires in terms of combinations of named attributes, referred to herein as Resource Requirements (RR 12.). Resource Selection Criteria (RSC 14) describe which resources would be acceptable for use by a Task. RR 12 is a group of named RSC, all of which must be satisfied to meet the RR. A Task may have any number of prioritized RR 12, any one of which is acceptable for the needs of the task. A higher priority RR 12 merely states a preference for that RR rather than another. A task's complete resource requirements can thus be described as a set of named RSC 14, and the resource manager is capable of supporting alternative resource requirements for a given task and prioritizing across all tasks T and all RR by attaching a priority to each RR 12 and allowing acquisition of alternative RR per each task.

To this end, a resource manager in accordance with the present invention employs a greedy simultaneous acquisition approach to ensure that the system is deadlock-free. It is still possible for some external client, though, to acquire a first resource A and then attempt to acquire a second resource B, while another external client has acquired B and is attempting to acquire A. For optimal use of resources, clients should acquire the required resources all simultaneously at the beginning of the task. Resources can be released either simultaneously or a few at a time with no difficulty. The resource manager selects simultaneously one distinct resource from each of N possibly overlapping sets of candidate resources such that any given selection is chosen with equal probability (i.e. is fair.)

Greedy acquisition has the advantage that it keeps the resources as busy as possible at any given moment. The resource manager also gains significant performance by maintaining for each resource S a set of RSC 14 that match it, and for each RSC 14 a set of available matching resources Sⱼ. The resource manager is able to quickly select random tasks for execution, preferring high priority RR, until no more tasks can be executed with the currently known available resources. As Resources are freed by the Tasks (e.g., a WQM test completes execution or no longer needs the Resource), or additional Resources are added to the system, the resource manager quickly identifies which other Tasks, if any, can be executed.

System Hardware Overview

In another aspect, the present invention provides a processor-readable computer program product encoded on one or more programmable storage devices and executable by one or more processors to perform method steps described herein for managing a plurality of resources S of a system for servicing a plurality of tasks T. A processor executing the software code of the processor-readable media would perform the steps described below of the resource manager. Such a processor is part of system including data communications medium (wired or wireless) between the processor and the resources and resource controllers and a main memory, such as a random access memory (RAM) or other dynamic storage device for storing information and instructions to be executed by the processor. The main memory also may be used for storing temporary variables or other intermediate information during execution of instructions by the processor. A storage device, such as a magnetic disk or optical disk, may also be provided for storing information and instructions.

The phrase “processor-readable computer program product” as used herein refers to any medium that participates in providing data that causes a machine to operation in a specific fashion. Such a medium may take many forms, including but not limited to, non-volatile media, volatile media, and transmission media. Non-volatile media includes, for example, optical or magnetic disks. Volatile media includes dynamic memory, such as main memory. Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

The system also includes a communication interface coupled to a bus for data communications among the resources and the resource manager. Communication interfaces preferably provide a two-way data communication coupling to a network link that is connected to a local network. For example, the communication interface may be an integrated services digital network (ISDN) card or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

System Software Overview

Internal Structures

A “resource”, as used herein, has no identity in and of itself. Rather, a resource is simply its named attributes. Consequently, it is not possible to have two resources that are identical across all named attributes. For resources that are known to have independent identity, adding a unique “id” attribute to such resources is an approach to guaranteeing independent treatment. Any given attribute has a name and a set of values. The term “set” is used herein in the mathematical sense, in that there is no order implied or considered.

With reference again to FIG. 1, a “Resource Selection Criteria” (RSC 14) describes what resource would be acceptable for use by a task. Each RSC is preferably expressed as a boolean expression in a primitive term form such as, for example, “a resource's named attribute contains a particular value”, “a resource's named attribute contains a value matching a regular expression”, and “a resource is identical to a particular resource with respect to all named attributes.” Arbitrarily complex RSC can be constructed using combinations of these forms. For example, a resource with “services={a, b, c}” would match a selection criteria with “services contains b”.

A “Resource Requirements” (RR 12) is a group of named RSC 14, all of which must be satisfied to meet the RR 12. The RR 12 describes the exact set of resources that a Task is requesting. In order to satisfy a requirement, a distinct available resource must be assigned to each of the named RSC, without duplication. The same available resource cannot be assigned to more than one named RSC simultaneously. In the event that a RR 12 is satisfiable, meaning that there is at least one combination of resources S that can be assigned to the multiple RSC C, the present invention provides that each of such combinations are selected with uniform probability.

As used herein, a “Task” (such as Task 10) is a set of prioritized RR. The RR are attempted in priority order, and the task is eventually assigned a set of resources satisfying the highest priority satisfiable RR. In other words, if the Task is assigned a set of resources satisfying RR “X”, there is guaranteed to be no higher priority RR “Y” for that Task which could be satisfied with the available resources.

FIG. 2 provides non-limiting examples of resources 16A-16D (characterized by their attributes 18) representing Identity Modules (IM's) in a WQM embodiment. International Mobile Station Identities (IMSIs) are much longer in reality, but are unique identifiers for the IMs. Note that resource 16A and 16B are identical except for their IMSI. This is a common case. Resources 16A-16D are completely described by their attributes 18, which can be multi-valued (e.g., Supported Services.) If a RSC is considered that is expressed as

not (PLMN contains Vodaphone) and (Supported Services contains Speech) and (Supported Services contains FAX),

then only resource 16D satisfies the RSC. In general, a large number of resources will satisfy any given RSC.

Tasks, RRs, RSCs, and Resources are all directly user-visible, external elements in a preferred embodiment of the present invention, and are constructed to express the domain entities. Tasks are also associated with “call-back”, which is invoked when a Task is assigned resources in order to hand off to the Task the assigned, named resources. The resources are named with the same names used in the RR to name the RSC. A Resource matching a RSC named B would be passed back with the name B, thereby allowing the Task to easily associate the assigned Resources. The only relationships between these external structures comprise the relationship that a Task has prioritized RR, and a RR has named RSC. There is no explicit relationship to Resources, just an implicit one of Resources that satisfy the RSC.

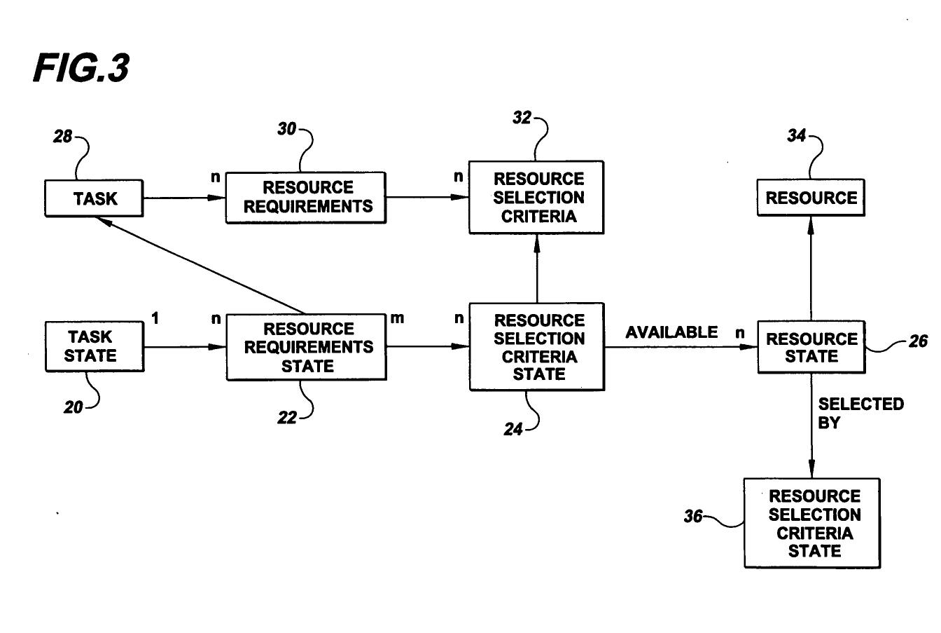

With reference to FIG. 3, there are four internal structures that “wrap” the external structures: TaskState 20, ResourceRequirementState (RRS 22), Resource Selection CriteriaState (RSCS 24), and ResourceState (RS 26.) The internal structures can maintain additional information that is of no concern to a user, and which the user should not be exposed to. Each TaskState 20 has associated prioritized RRS 22 that are not shared (i.e., they are unique to a given TaskState 20.) Each RRS 22 has associated named RSCS 24, as well as the Task 28 which has the RR 30 corresponding to the RRS 22. RSCS 24 are shared; any two RSC 32 which are identical can use the same RSCS 24.

Each RSCS 24 has its corresponding RSC 32, and also a set of the ResourceStates (RS 26) for the Resources 34 that are selected by the RSC 32 and that are currently available. As mentioned above, RSCS 24 are shared. Since an RSC 32 simply is a boolean expression, the same boolean expression can be used interchangeably throughout. Each RS 26 has its corresponding Resource 34, a set of the RSCS 36 that select Resource 34, and a flag marking whether Resource 34 is available or not. Each RSCS 36 keeps track of only those Resources 34 which they each respectively select and that are available for use. Each RS 26 keeps track of all the RSCS which selects it, whether the Resource 34 is available for use or not. As resources are acquired and released, the RSCS 24,36 are updated to keep them “in synch.”

The “States” 20,22,24,26,36 have identity semantics, rather than value semantics. The externally visible elements 28,30,32,34 have value semantics, meaning that any two equivalent Resources, for example, are interchangeable Resources. They also have relatively short lifetimes, unlike the “States” and, in particular, the RSCS 24,36 and RS 26, which have very long lifetimes and are used to make explicit the implicit relationship between RSC 32 and the Resources 34 that they select. The use of “States” is important in practice, since the externally visible elements (Tasks 28, RR 30,RSC 32, Resources 34, etc.) may be accessed and used from another process in another address space. In such an environment the Resource that is released is not the identical Resource that was acquired, but instead an equivalent Resource with identical attributes. By dealing with the States and collections of States internally, lookup and matching operations are able to run much more quickly in the depths of the resource management algorithms provided by the present invention.

Resource Acquisition and Release

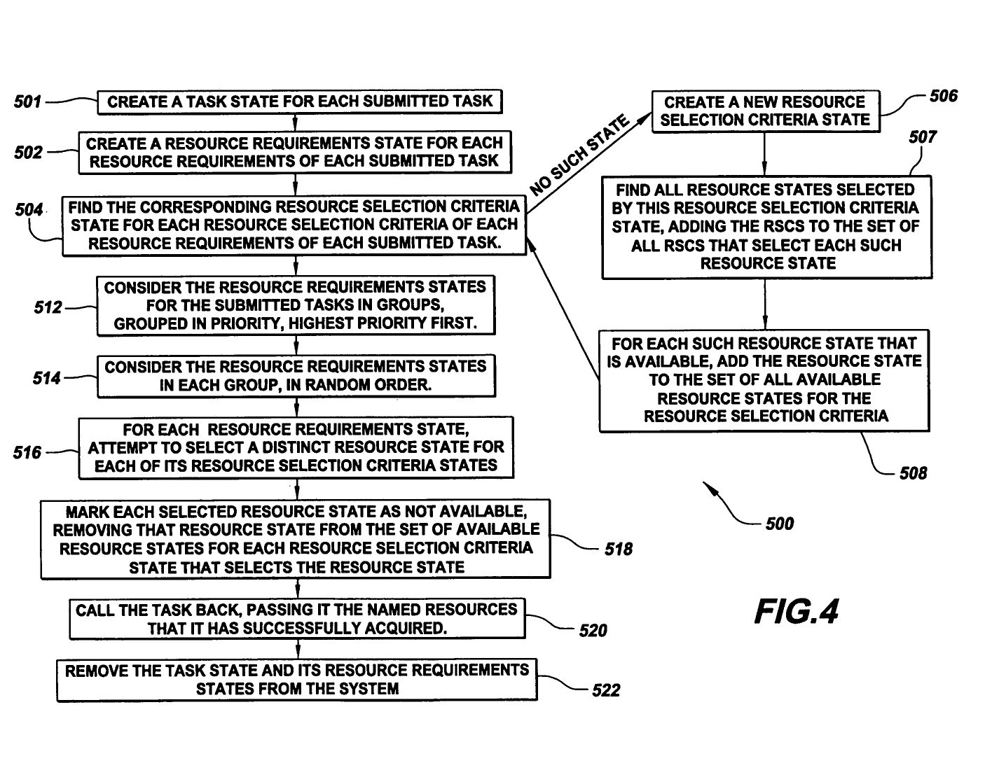

The present invention utilizes a greedy simultaneous acquisition approach to acquiring all the resources need for a task, which will now described with reference to FIG. 4, which illustrates a flowchart representing software-implemented method 500 performed by the resource manager when a task or tasks are submitted.

In step 501, a TaskState is created for each submitted Task Tₖ. A RRS is then created for each RR Rᵢ of each submitted Task Tₖ (step 502.) Then in step 504 the corresponding RSCS for each RSC Cᵢ of each RR Rᵢ of each submitted Task is found.

In steps 506-508, if no such RSCS is found (i.e., no RCSC CORRESPONDS TO THIS RSC), a new RSCS is created, all RS selected by the newly created RSCS are found, adding the RSCS to the set of all RSCS that select each such RS, and for each such RS that is available, adding the RS to the set of all available RS for the RSC Cᵢ. Performing steps 506-508 results in a scan through all Resources, which is performed as needed, but rarely required in practice.

In step 512, the RRS for the submitted Tasks are considered in groups, grouped by priority, highest priority first, and in random order within each group (step 514.)

In steps 516-522, as an atomic operation, for each RR Rᵢ associated with a task Tₖ requiring execution, the resource manager attempts to choose a group of available resources Sⱼ satisfying RR Rᵢ such that no resource in Sⱼ is selected more than once. If such a group of available resources Sⱼ exists and is chosen, the resource manager then acquires the available resources Sⱼ, making the acquired available resources Sⱼ no longer available, and then hands off the available resources Sⱼ to the task Tₖ and removes the TaskState corresponding to Tₖ and all RRSs associated with that TaskState from the system. The RSCs associated with Tₖ all still maintained, and not removed from the system. Expressed in terms of the States representing the tasks, resources, resource requirements and resource selection criteria, in step 516, for each RRS, the resource manager attempts to select a distinct RS for each of its RSCS. Each selected RS is marked as not available, removing that RS from the set of available RS for each RSCS that selects that RS in step 518. In step 520, the Task Tₖ is “called back” and handed the named Resources that were successfully acquired. And in step 522, the TaskState and its RRS are removed from the system. Looping is implicit through steps 516-522, with each group of RRS considered in series within a current group, and the groups considered in series. Processing continues until there are no remaining groups.

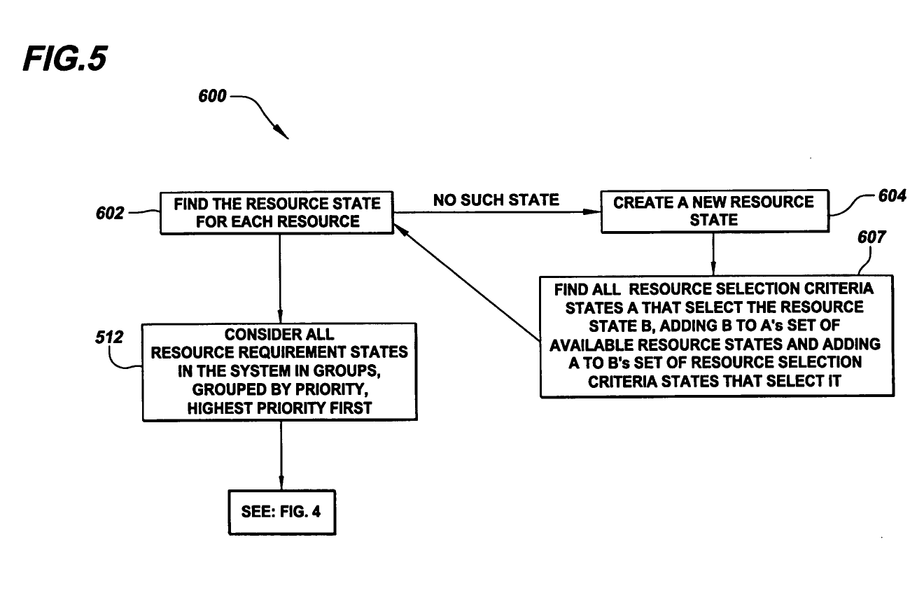

The other “entry point” to the processes performed by the resource manager occurs when resources are released, or added, to the system. It is at these times only that a task may become ready to run. With reference to FIG. 5, method 600 is initiated when Resources are released or added to the system.

In steps 602-606, resources are added to the system by determining which RSCS A that select the RS B for each Resource not already known to the system, by simple iteration over all RSCS, adding B to A's set of available RS and adding A to B's set of RSCS that select it. From that step forward, processing proceeds identically to that of method 500, starting at step 512. By definition, a released Resource never follows the “no such State” path from step 602 to step 604. In contrast, new resources always take the “no such State” path.

Several features and/or techniques for enhancing performance and scalability of the system are worthy of restatement. RSC are shared implicitly across multiple Tasks. Each Task has multiple RR, which are not shared, and each RR has multiple named RSC, all of which must be satisfied simultaneously for a task to run. In practice, there are only so many distinct RSC in the system, typically far fewer than the number of Tasks. Secondly, the system explicitly maintains for all known RSC Cᵢ a group of available Resources Sⱼ which satisfy Cᵢ, and, for all known Resources Uᵢ, a group of RSC criteria Cⱼ which Uᵢ satisfies. Third, the RSCS are maintained over very long periods of time, much longer than the execution of any particular Task. A Task is expected to be executed periodically (e.g., in the WQM), so all executions of the same Task may reuse the same RSCS, internally. Since both the RSCS and the Resources are very long-lived, it may only be necessary to determine which Resources are selected by which RSCS when a Resource or a RSCS is added to the system. Fourth, for each Resource, the system keeps track of which RSC selects the Resource, and for each RSC, the system keeps track of which currently available Resources Sⱼ it selects.

In combination, these techniques greatly reduce the amount of time required to find a Task that can be run given the available Resources. No searching is required: a fast check simply involves checking each RR to determine if all of its associated RSC have at least one available Resource.

Uniform Random Selection of Resource Groups

One operational consideration is that the RSC in a given set might select sets of possible Resources that are not disjoint. Thus, the random selection of Resources must be uniform across the possible selections without duplicates. For example, RSC-1 might match available resources {a, b}, and RSC-2 might match available resources {b, c}. This yields three possible Resource selections for the set: (1→a, 2→b), (1→a, 2→c), and (1→b, 2→c). The Resource selection (1→b, 2→b) is not possible since Resources are allocated exclusively (i.e., RSC-1 and RSC-2 cannot both acquire resource b simultaneously.) The Resource acquisition approach must involve selecting one of the three possible selections with equal probability.

Any given Task may have multiple sets of RSC associated with it, each with its own priority. This allows a Task, in essence, to convey the message “I would prefer X, but would settle for Y, and if not that, then Z.” The system applies priorities across Tasks, with the highest priority sets of RSC having preferential access to available Resources. Thus, for the example, prioritization of multiple Task might result in the following ordering: Task A with RSC X, then Task B with RSC Y, then Task A with RSC Z.

This issue corresponds to step 516 in process 500 and involves determining how to select one resource for each of N RSC, such that the same Resource is not used for more than one RSC and that the selection is done at random, meaning each valid “resource group” is selected uniformly.

There are two obvious ways to perform such a selection. First one Resource could be chosen at random for each RSC, repeating the choosing from the beginning until there are no duplicates, but involves re-selecting all resources. Otherwise certain combinations would be over-represented in the result. Second, all valid (or “legal”) combinations of Resources could be generated, and one such combination then selected.

The “choose and repeat” method has some disadvantages. In particular, there may be no legal combinations of Resources, even though each RSC has at least one available Resource. The obvious case is choosing from {A}, {A}. Even if there are legal combinations, the number of them might be a very small fraction of the total number of combinations. To illustrate, choosing five uniquely from set {A, B, C, D, E} presents 5!=120 legal combinations, but 5ˆ5=3125 total combinations. A significant number of random attempts could be required before finding a legal combination. As another example, choosing six uniquely from {A} {A, B} {A, B, C} . . . {A, B, C, D, E, F} may have only one valid combination, but 6!=720 total combinations.

Generating all valid combinations also has disadvantages. Some of the sets of available Resources could contain hundreds or thousands of Resources, and the combinatorial explosion quickly leads to very large numbers of combinations. An approach that completely expands for small sets and probes for large sets could be used, but still leaves the large “gray area” in the middle.

A practical solution to this problem requires developing information about the minimum number of legal combinations and the total number of combinations for a group of sets Sᵢ.

The total number of combinations is simply the product of the sizes of Sᵢ.

In order to ascertain a minimum number of legal combinations, the sets Sᵢ are first placed in non-decreasing order by size, i.e., smallest set first. Then the minimum number of legal combinations is calculated as the product (size(Sᵢ)-i), with zero-based indices. This formula can be verified intuitively as follows. The worst case for the number of legal combinations occurs when each set Sᵢ is a subset of Sᵢ₊₁,. In that case, any selection desired can be made from the zeroth set, S₀. From the next set, for any given choice from the zeroth set, one can only choose size(Sᵢ)−1 entries: for each choice from the zeroth set, one of the entries in the first set would be a duplicate. Similarly, two of the entries in S₂ are possibly duplicates, etc.

As a side note, the number of permutations drawing n from a sample of N is N!/(N−n}!. In the paragraph above, that would correspond to n identical sets of size N. Expanding, one obtains the product (N-i) for i valued zero through n-1, which is exactly the result above.

In brief, the approach employed is to form a collection of legal combinations of Sᵢ, but only up to some m≦n. The expansion of this collection is performed one set at a time, until the expected cost of random sampling becomes less than the cost of another step of expansion.

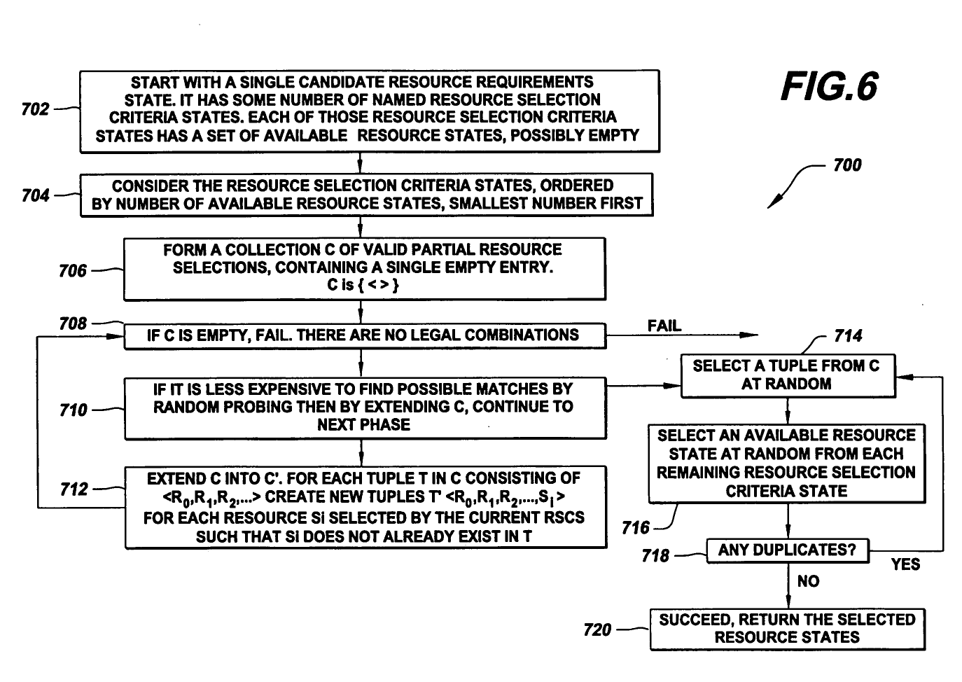

A method 700 in accordance with these principles is illustrated in FIG. 6. In step 702, for each named RSC Cⱼ in RR Rᵢ, the resource manager looks up the group of available Resources Sⱼ that satisfy Cⱼ. This set may possibly be empty. In step 704, the available Resources Sⱼ are ordered by the number of available Resources in Sⱼ, least number of available resources first (i.e., so as to consider the smallest sets first.)

In step 706, a collection of partial resource selections Dₖ is constructed comprised of one available Resource each from S_{0 . . . m-1} such that Dₖ contains no resource more than once. In step 706, the collection will contain a single empty entry, {< >}, representing one possibility so far, with additions to follow.

Iterative steps 708-718 serve to randomly select one partial resource selection Dₖ and one available Resource each from the remaining S_{m . . . n-1} such that the group of Resources contains no Resource more than once, so as to obtain a final group of Resources. In step 708, the process is failed, returning no legal combinations if the collection is determined to be empty, otherwise the process continues to step 710. A determination is made in step 710 whether it is less expensive to find possible matches by random probing than by extending D. The relative cost of extending D into D′ is calculated by adding in the current set Sᵢ as the product, size(D)×size(Sᵢ) (i.e., the number of resources in the current set.) The relative cost of performing the random selection step is calculated as product(size(Sⱼ))_{i . . . n-1}/product(size(Sⱼ)j)_{i . . . n-1}. The expected number of random probes to find a legal combination is the total number of combinations divided by the minimum number of legal combinations. This is a pessimistic estimate, since at this point the actual number of legal combinations is not known. The cost of each random probe is roughly 1+the number of remaining sets (choose one from D, then one from each remaining Sᵢ, checking for duplicates.)

If the expected cost of probing is less than the cost of expanding D, the process moves to iterative steps 714-718, wherein tuples are iteratively selected from D and Resources Rᵢ from each remaining Sᵢ until the process exits at step 720 with a non-duplicative set D of legal combinations.

Otherwise, if the expected cost of extending D to D′ is less than the cost of random probing, the process moves to iterative step 712 for extending D by adding Sᵢ by constructing multiple partial resource selections Dₖ from Dⱼ in D, each Dₖ comprised of Dⱼ extended by a single resource Uₗ, from Sᵢ such that Dⱼ does not contain Uₗ. In step 712, for each tuple T in D consisting of <R₀,R₁,R₂, . . . Sᵢ>, new tuples T′ <R₀,R₁,R₂, . . . ,Sᵢ>are created for each Resource Sᵢ selected by the current RSCS such that Sᵢ does not already exist in T.

In situations where all of the sets are small (i.e., not many available resources), generating combinations is preferred, and may be the only algorithm used. In situations where all of the sets are large (lots of available resources), random probing may be the only algorithm used. An explicit trade-off may be made, where one algorithm is used initially (where the first few sets are small) and the other at the end (the remaining are large), resulting in good performance.

Uniform Random Selection of Tasks

Uniform random selection of Tasks is straightforward. The solution actually tracks RS rather than Tasks, since a given task can have multiple Requirements. The RS are grouped by priority, so they may be considered in a decreasing priority order. Within each group, the RS are shuffled into random order, and then processed one at a time. This approach guarantees that each RS is processed, and also that the order is random within priority group.

Data Structure for Fast Add/Remove/Contains and Random Selection

The RSCS each need to manage their collection of matching available RS. That collection can be large, is modified frequently, and must support fast random selection. A Java Set meets all the criteria except for fast random selection. A Java ArrayList supports fast random selection, but takes linear time for modification.

The data structure used combines a Java Map and ArrayList. The ArrayList holds the elements, in no particular order, and supports fast random selection. The Map maps the elements to their indices in the ArrayList.

Adding an element requires checking the Map to see if the element is already present. If it isn't, the element is added to the end of the List, and the entry element->index is added to the Map.

Removing an element causes a lookup in the Map to find the index. If the element is present, the last element in the list is swapped (in the list) with the to-be-removed element, updating the indices in the Map. Then the element is removed from both the Map and the list, an O(1) operation.

Testing to see if the element is present is just a Map lookup. Selecting an element at random is accomplished in the List. An ArrayList is used, providing O(1) access to any element.

Example WQM Embodiment

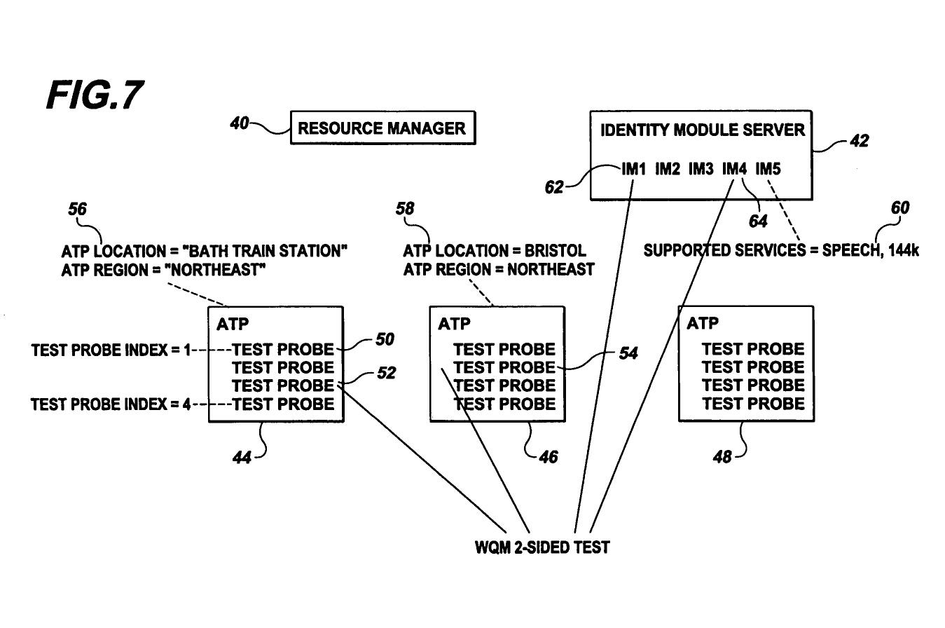

With reference to a preferred embodiment shown in FIG. 7, a resource manager 40 in accordance with the present invention may be implemented with the WQM system, many aspects of which are described at: http://we.home.agilent.com/cgi-bin/bvpub/agilent/Product/cp_Productjsp?OID=536882909&NAV_ID=-536885380.536882909.00&LANGUAGE_CODE=eng&COUNTRY_CODE=ZZ&CT=PRO DUCT&JPID=/comms/firehunter, the contents of which are incorporated herein by reference. A WQM system typically includes a centralized server 42 for thousands of IM's, and potentially hundreds of geographically distributed ATPs 44,46,48, each having approximately six uniquely identified Interface Cards such as interface cards such as Interface Cards 50, 52 and 54. Resource Manager 40 acquires each of these resources, as needed to accomplish tasks in a test flow, in an efficient manner that assures fairness and high utilization rates for jointly shared resources in high demand.

In a preferred embodiment of the present invention, each of the Active Test Probe 44, 46, 48 is an individual agent in the system, and may have some portion of resource manager software code resident upon them, but other configurations are possible and fall within the scope of the present invention. Each agent should possess servlet functionality, even though such functionality may not be used in respect of a given servlet according to a particular system configuration.

A single “A to B” test within WQM must acquire two interfaces, one for point A and one for point B; and two IMs for those two interfaces. In practice, the IMs and the interfaces are rather broadly specified, meaning that the selection criteria that choose them could potentially select a significant number of resources. As a specific example, there are typically multiple interfaces in a single physical location. Any of those interfaces would be adequate for the test.

The test can acquire these resources by: creating a new Task; creating a new ResourceRequirement with nominal priority; adding four Criteria to that ResourceRequirement: one for each interface, and one for each SIM; and submitting the Task to a Resource Manager 40.

Each resource of the plurality of resources S in the system is characterized by at least one named attribute such as, for example, attributes 56,58,60, where any given attribute may have multiple values. For example, in WQM, IMs are characterized and selectable by SupportedServices, by PLMN (Public Land Mobile Network), by Country Code and possibly other attributes. Interface Cards are selected by ATPLocation, ATPRegion, ATPCountry (which are successively less restrictive specifiers of the physical location of an Interface Card), by Supported Service, and possibly other attributes. A WQM two-sided test typically requires management of multiple resources, including, on the “A” side, a test probe interface card A 52 of Active Test Probe 44 and an IM1 62, each having the desired characteristics, and similar resources on the “B” side, i.e., test probe interface card B 54 of Active Test Probe 46 and IM4 64. The two IMs must be distinct identity modules (representing distinct actual resources), and the two interface cards must also be distinct (e.g., no calling from and to the same card.) The resource manager 40 efficiently acquires and hands off the references to the tasks required to the test the system, using the methods as described above.

The present invention may be employed successfully over a wide range of wireless network types and standards, including, but not limited to, wifi 802.11a, wifi 802.11b, wifi 802.11g, wimax, GSM/GPRS and CDMA, as well as other standards yet to be devised or implemented. Moreover, the present invention is not limited in scope to wireless multi-sided test applications, and includes within its scope wireline test applications such as Ethernet/LAN and dial-up networks.

Although the invention has been described with respect to various embodiments, it should be realized this invention is also capable of a wide variety of further and other embodiment within the spirit of the invention.

It is claimed:

1. In a system including a plurality of resources S for servicing a plurality of tasks T, a software-implemented method of resource management, comprising the steps of:
upon task submission and release of resources, as an atomic operation, for each resource requirement Rᵢ of a plurality of resource requirements R each associated with a task Tₖ requiring execution, in random order:
choosing a group of available resources Sⱼ satisfying resource requirements Rᵢ such that no resource in Sⱼ is selected more than once;
if a group of available resources Sⱼ has been chosen:
acquiring the chosen available resources Sⱼ, making the acquired available resources Sⱼ no longer available;
handing off the available resources Sⱼ to Tₖ; and
removing all resource requirements Rᵢ from the plurality of resource requirements R.

2. The method of claim 1, wherein:
each of the plurality of resources S is characterized by one or more named attributes each having at least one value;
each of the plurality of resource requirements Rᵢ is characterized by a group of at least one named resource selection criteria C;
each of the resource selection criteria is expressed as a boolean expression in a primitive term form selected from the group consisting of (a) a resource's named attribute contains a particular value,(b) a resource's named attribute contains a value matching a regular expression, and (c) a resource is identical to a particular resource with respect to all named attributes.

3. The method of claim 1, wherein:
at least one resource requirement Rᵢ is associated with each task Tₖ requiring execution;
each resource requirement Rᵢ has some priority Pⱼ; and
the resources are acquired by considering the plurality of resource requirements R in prioritized groups, highest priority first, such that all resource requirements Rᵢ in each group have the same priority Pⱼ and the resource requirements Rᵢ are considered in random order within each group.

4. The method of claim 1, wherein the group of available resources Sⱼ satisfying the resource requirements Rᵢ is chosen with equal probability from the set of all such groups Sₖ satisfying Rᵢ.

5. The method of claim 2, further comprising the steps of:
adding each resource selection criterion Cᵢ associated with each resource requirement Rⱼ associated with each submitted task Tₖ to the set of all known resource selection criteria C;
explicitly maintaining for all known resource selection criteria C1 the group of available resources Sⱼ which satisfy Cᵢ; and
explicitly maintaining for all known resources U1 the group of resource selection criteria Cⱼ which Uᵢ satisfies;
wherein any two identical resource selection criteria are considered to be the same resource selection criterion.

6. The method of claim 5, wherein the choosing step further comprises the steps of:
for each named resource selection criterion Cj in resource requirement Ri, looking up the group of available resources Sj that satisfy Cj;
ordering Sⱼ by number of available resources in Sⱼ, least number of available resources first;
constructing a group of partial resource selections Dₖ comprised of one available resource each from S_{0 . . . m-1} such that Dₖ contains no resource more than once; and
randomly selecting one partial resource selection Dₖ and one available resource each from the remaining S_{m . . . n-1} such that the group of resources contains no resource more than once, thereby obtaining a final group of resources.

7. The method of claim 6, wherein the construction step further comprises the steps of:
constructing an initial group of partial resource selections D comprised of the single partial resource selection D₀ containing no resources;
iteratively considering each Sᵢ in order by size:
if D contains no partial resource selections, aborting the choosing step with no possible choice;
determining the relative cost of extending D into D′ by adding Sᵢ as size(D)×size(Sᵢ);
determining the relative cost of performing the random selection step as product(size(Sⱼ))_{i . . . n-1}/product(size(Sj)−j)_{i . . . n-1};
if performing the random selection is less expensive than extending D, returning D as the result of the construction step, otherwise extending D into D′ adding Sᵢ by constructing multiple partial resource selections Dₖ from Dⱼ in D, each Dₖ comprised of Dⱼ extended by a single resource Uₗ, from Sᵢ such that Dⱼ does not contain Uₗ.

8. A system for managing a plurality of resources for servicing a plurality of tasks, the system comprising:
a plurality of resources S for servicing a plurality of tasks T, each of the plurality of resources S characterized by one or more named attributes each having at least one value;
a plurality of resource requirements R, each resource Rᵢ of the plurality of resource requirements associated with a task Tₖ requiring execution and characterized by a group of at least one named resource selection criteria C;
a resource manager for, upon task submission and release of resources, as an atomic operation, for each resource requirement Rᵢ, in random order:
choosing a group of available resources Sⱼ satisfying resource requirements Rᵢ such that no resource in Sⱼ is selected more than once;
if a group of available resources Sⱼ has been chosen:
acquiring the chosen available resources Sⱼ, making the acquired available resources Sⱼ no longer available;
handing off the available resources Sⱼ to Tₖ; and
removing all resource requirements Rₗ from the plurality of resource requirements R.

9. The system of claim 8, wherein each of the resource selection criteria is expressed as a boolean expression in a primitive term form selected from the group consisting of (a) a resource's named attribute contains a particular value,(b) a resource's named attribute contains a value matching a regular expression, and (c) a resource is identical to a particular resource with respect to all named attributes.

10. The system of claim 8, wherein:
at least one resource requirement Rᵢ is associated with each task Tₖ requiring execution;
each resource requirement Rᵢ has some priority Pⱼ; and
the resource manager acquires the resources by considering the plurality of resource requirements R in prioritized groups, highest priority first, such that all resource requirements Rᵢ in each group have the same priority Pⱼ and the resource requirements Rᵢ are considered in random order within each group.

11. The system of claim 8, wherein the resource manager chooses the group of available resources Sⱼ satisfying the resource requirements Rᵢ with equal probability from the set of all such groups Sₖ satisfying Rᵢ.

12. The system of claim 9, wherein the resource manager is further adapted to:
add each resource selection criterion Cᵢ associated with each resource requirement Rⱼ associated with each submitted task Tₖ to the set of all known resource selection criteria C;
explicitly maintain for all known resource selection criteria Cᵢ the group of available resources Sⱼ which satisfy Cᵢ; and
explicitly maintain for all known resources Uᵢ the group of resource selection criteria Cⱼ which Uᵢ satisfies;
wherein any two identical resource selection criteria are considered to be the same resource selection criterion.

13. The system of claim 12, wherein the resource manager is further adapted to:
for each named resource selection criterion Cj in resource requirement Ri, look up the group of available resources Sj that satisfy Cj;
order Sⱼ by number of available resources in Sⱼ, least number of available resources first;
construct a group of partial resource selections Dₖ comprised of one available resource each from S_{0 . . . m-1} such that Dₖ contains no resource more than once; and
randomly select one partial resource selection Dₖ and one available resource each from the remaining S_{m . . . n-1} such that the group of resources contains no resource more than once, thereby obtaining a final group of resources.

14. The system of claim 13, wherein the resource manager is further adapted to:
construct an initial group of partial resource selections D comprised of the single partial resource selection D₀ containing no resources;
iteratively consider each Sᵢ in order by size:
if D contains no partial resource selections, abort the choosing step with no possible choice;
determine the relative cost of extending D into D′ by adding Sᵢ as size(D)×size(Sᵢ);
determine the relative cost of performing the random selection step as product(size(Sⱼ))_{i . . . n-1}/product(size(Sj)−j)_{i . . . n-1};
if performing the random selection is less expensive than extending D, return D as the result of the construction step, otherwise extend D into D′ adding Sᵢ by constructing multiple partial resource selections Dₖ from Dⱼ in D, each Dₖ comprised of Dⱼ extended by a single resource Uₗ, from Sᵢ such that Dⱼ does not contain Uₗ.

15. A processor-readable computer program product encoded on one or more programmable storage devices, the computer program product executable by one or more processors to perform method steps for managing a plurality of resources S of a system for servicing a plurality of tasks T, comprising instructions for:
upon task submission and release of resources, as an atomic operation, for each resource requirement Rᵢ of a plurality of resource requirements R each associated with a task Tₖ requiring execution, in random order:
choosing a group of available resources Sⱼ satisfying resource requirements Rᵢ such that no resource in Sⱼ is selected more than once;
if a group of available resources Sⱼ has been chosen:
acquiring the chosen available resources Sⱼ, making the acquired available resources Sⱼ no longer available;
handing off the available resources Sⱼ to Tₖ; and
removing all resource requirements Rᵢ from the plurality of resource requirements R.

16. The computer program product of claim 15, wherein:
each of the plurality of resources S is characterized by one or more named attributes each having at least one value;
each of the plurality of resource requirements Rᵢ is characterized by a group of at least one named resource selection criteria C;
each of the resource selection criteria is expressed as a boolean expression in a primitive term form selected from the group consisting of (a) a resource's named attribute contains a particular value, (b) a resource's named attribute contains a value matching a regular expression, and (c) a resource is identical to a particular resource with respect to all named attributes.

17. The computer program product of claim 1, wherein:
at least one resource requirement Rᵢ is associated with each task Tₖ requiring execution;
each resource requirement Rᵢ has some priority Pⱼ; and
the resources are acquired by considering the plurality of resource requirements R in prioritized groups, highest priority first, such that all resource requirements Rᵢ in each group have the same priority Pⱼ and the resource requirements Rᵢ are considered in random order within each group.

18. The computer program product of claim 15, further comprising instructions for choosing the group of available resources Sⱼ satisfying the resource requirements Rᵢ with equal probability from the set of all such groups Sₖ satisfying Rᵢ.

19. The computer program product of claim 16, further comprising instructions for:
adding each resource selection criterion Cᵢ associated with each resource requirement Rⱼ associated with each submitted task Tₖ to the set of all known resource selection criteria C;
explicitly maintaining for all known resource selection criteria Cᵢ the group of available resources Sⱼ which satisfy Cᵢ; and
explicitly maintaining for all known resources Uᵢ the group of resource selection criteria Cⱼ which Uᵢ satisfies;
wherein any two identical resource selection criteria are considered to be the same resource selection criterion.

20. The computer program product of claim 19, further comprising instructions for:
for each named resource selection criterion Cj in resource requirement Ri, looking up the group of available resources Sj that satisfy Cj;
ordering Sⱼ by number of available resources in Sⱼ, least number of available resources first;
constructing a group of partial resource selections Dₖ comprised of one available resource each from S_{0 . . . m-1} such that Dₖ contains no resource more than once; and
randomly selecting one partial resource selection Dₖ and one available resource each from the remaining S_{m . . . n-1} such that the group of resources contains no resource more than once, thereby obtaining a final group of resources.

21. The computer program product of claim 20, further comprising instructions for:
constructing an initial group of partial resource selections D comprised of the single partial resource selection D₀ containing no resources;
iteratively considering each Sᵢ in order by size:
if D contains no partial resource selections, aborting the choosing step with no possible choice;
determining the relative cost of extending D into D′ by adding Sᵢ as size(D)×size(Sᵢ);
determining the relative cost of performing the random selection step as product(size(Sⱼ))_{i . . . n-1}/product(size(Sj)-j)_{i . . . n-1};
if performing the random selection is less expensive than extending D, returning D as the result of the construction step, otherwise extending D into D′ adding Sᵢ by constructing multiple partial resource selections Dₖ from Dⱼ in D, each Dₖ comprised of Dⱼ extended by a single resource Uₗ from Sᵢ such that Dⱼ does not contain Uₗ.
